(19) United States
(12) Patent Application Publication
(10) Pub. No.: US 2025/0095313 A1
(43) Pub. Date: Mar. 20, 2025

(54) PERSONALIZED THEME UNIQUE TO A PERSON

(71) Applicants: Sony Interactive Entertainment Inc., Tokyo (JP); Sony Interactive Entertainment LLC, San Mateo, CA (US)

(72) Inventors: Mahdi Azmandian, San Mateo, CA (US); Sarah Karp, San Mateo, CA (US); Elizabeth Osborne, San Mateo, CA (US); Angela Wu, San Mateo, CA (US)

(21) Appl. No.: 18/470,361

(22) Filed: Sep. 19, 2023

(51) Int. Cl. G06T 19/20

(52) U.S. Cl. CPC G06T 19/20; G06T 2200/24; G06T 2219/2024

(57) ABSTRACT

Methods and systems for defining a theme for a user to share with other users includes presenting a plurality of images available to a user account of a user, wherein each image includes features to distinctly identify different portions of the image. Select ones of the plurality of images selected by the user are provided to a generative AI, which analyzes the features included in the different portions to determine a theme and generate an output image for the theme. Additional inputs received from user selection of content adjusters provided alongside the output image are provided to the generative AI to further refine the output image. The refined output image is used to define a representative image for the theme and is provided to the user to specify usage of the refined output image during online interactions of the user.

### BACKGROUND OF THE INVENTION

### 1. Field of the Invention

The present disclosure relates to personalizing a theme unique to a user and generating an image representing the theme for use to represent the user during interaction in an interactive application.

### 2. Description of the Related Art

User interaction with online content has become mainstream with a variety of content being presented or generated for user consumption. As the user interacts with various content available on the Internet, the user is recognized using his avatar or icon. The user is able to customize their avatar by adjusting the rendering attributes. The user is, however, severely restricted in their ability to customize a unique theme that can be uniquely associated with them and used to distinctly recognize the user.

It is in this context that embodiments of the invention arise.

### SUMMARY OF THE INVENTION

Implementations of the present disclosure relate to systems and methods for generating a theme using images uploaded by the user. The images may be unique to the user and can have nostalgic value. A theme generator, using generative artificial intelligence (AI), analyzes the uploaded images to identify the features included in each of the images and to identify a theme that is common or that is appropriate for the identified features of the images. In some implementations, in addition to uploading the images, the user may also provide text inputs to specify select ones of the images to use, specific features included in certain portions of one or more of the images to retain, specific features in certain portions of one or more of the images to discard, and/or features in certain portions of one or more images to enhance/replace/adjust. The generative AI uses the inputs from the user to consider the select ones of the images and the specific features from certain portions of one or more images to identify the theme. The generative AI creates a weighted histogram of the various features identified in the images and uses the weighted histogram to determine the theme. Once the theme is generated for the uploaded images of the user, the features of content and the generated theme can be further refined automatically by the generative AI or by using additional inputs from the user.

In some cases, the additional inputs for refining the theme and the output image for the theme can be provided at a user interface in the form of content adjusters. Each content adjuster may be used to adjust a distinct The content adjusters identify a feature of the content and the type of adjustment that needs to be done to the feature. In some cases, the content adjusters may be used to indicate specific portion(s) to retain and specific other portion(s) to discard in each image and the generative AI uses the details to filter out the unwanted portion. The content adjusters are interpreted and used to adjust the corresponding feature(s) of content by zooming, cropping, coloring, enhancing, and mixing the features of different images. An output image representing the theme is generated by blending the adjusted features of content identified for inclusion from the select ones of the uploaded images. The blending is done by integrating and arranging the images in a specific manner, wherein the specific manner may be based on the context of the content included in the images. The generated output image presents a customized representation of features from the images that are unique to the user or that are of significance to the user. The generated output image is used to represent the user during their interaction with an interactive application or for presenting during online interactions.

In some cases, the user can specify the area, the application, the default page or screen and/or utility where the output image created for the theme is to be used. For example, in some implementations, the user may specify that the output image is to be used to represent the user in one or more interactive applications. Alternatively or additionally, the user may specify that the output image of the theme is to be used in a home page or as a background screen or a navigation screen of an online media platform used by the user to access the interactive applications or navigate during online interactions. In such cases, the theme generated from the uploaded images can be used to customize the looks of the navigation buttons/interactive icons/applications available on the home page or the screen accessed by the user. In some other cases, the user may identify a portion of the output image to generate a decal for presenting on one or more devices or in one or more interactive applications. The decal can be used to identify the device associated with the user. The user identity can be used to automatically load the settings and user preferences on the appropriate devices (e.g., controller, head mounted displays, smart glasses, etc.) and/or interactive applications. The decal of the theme functions as a digital finger print for identifying the user, so that appropriate settings and preferences of the user can be identified and uploaded at the specific devices/interactive applications.

The theme generation engine using the generative AI provides selection options on a user interface identifying content of each image and features included in the content to allow the user to select which ones of the content/features to filter out, which ones of the content/features to retain, which ones of the content/features to adjust prior to the images being provided to the generative AI to generate the theme. And, after the theme is generated, the selection options are provided to further modify the features/content and use the modified features/content to refine the generated theme. The generated and refined theme and the output image generated for the theme are customized in accordance to the user's requirements by allowing the user to customize each and every feature of content that makes up the theme so that the output image generated for the theme is unique, personal and specific for the user.

In one implementation, a method for providing a theme for a user to share when interacting with other users, is disclosed. The method includes presenting a plurality of images available to a user account of the user on a user interface for user selection. Each image of the plurality of images includes features that distinctly identify different portions of the image. User selection of the select ones of the images for defining the theme received from the user interface is provided as inputs to a generative artificial intelligence (AI). The generative AI analyzes the features included in the different portions of each of the select ones of the images to determine the theme included within. The generative AI then generates an output image to represent the theme for the user. The output image is generated by blending the features from the select ones of the images. The output image is returned to the client device for rendering on the user interface. Additional inputs received for the output image from user selection of content adjusters are received and forwarded to the generative AI to further adjust the theme and refine the output image generated for the theme. The refining of the output image results in the generation of a representative image for the theme, which includes the selective features of the uploaded images and the adjustments to some of the selective features provided through content adjusters. The representative image is returned to the client device to allow the user to specify use of the representative image of the theme in the interactive application.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

The disclosure may be better understood by reference to the following description taken in conjunction with the accompanying drawings.

FIG. 1 represents a simplified block diagram of a system that is used to generate a theme using features of images uploaded by a user, in accordance with one implementation.

FIG. 2 illustrates a simplified block diagram of a theme generator module that engages generative artificial intelligence (AI) to identify features in images uploaded by the user and considering the features of the images to identify a theme and to generate an output image for the theme, in accordance with one implementation.

FIG. 3 illustrates a simplified data flow diagram used by the theme generator module to define a theme for the features included in images uploaded by the user, in accordance with one implementation.

FIG. 4 illustrates one example of a user interface on which content adjusters are provided to adjust one or more features of content of an output image defined for a theme (also referred to hereonwards as “theme image”) to refine the theme and the output image of the theme, in accordance with one implementation.

FIG. 5 illustrates one example of using the theme generator with generative AI to generate multiple versions and multiple dimension for a defined theme identified for features of content identified in the uploaded images, in accordance with some implementations.

FIGS. 6a-6c illustrate some examples of generating decals using features of content included in different portion of the output image, in accordance with some implementations.

FIG. 7 illustrates components of an example system that can be used to process requests from a user, provide content and assistance to the user to perform aspects of the various implementations of the present disclosure.

### DETAILED DESCRIPTION

Broadly speaking, implementations of the present disclosure include systems and methods for receiving images from or for a user and analyzing the images to identify a theme. The images can be unique or personal to the user and the theme generated from the images are customized to include the unique features extracted from the images. An output image that represents the theme is generated and returned to the user to further customize. The customized output image for the theme is provided to the user to allow the user to use during interaction with other users and/or to represent the user in interactive applications.

The images can be real-images that include real-world elements, such as real-world objects or scenes, or can be generated images that include generated elements. The generated elements can be virtual elements that mimic the look and behavior of the real-world elements or virtual elements that are exaggerated versions of the real-world elements. The images may be directly uploaded by the user or access to the images in user accounts (e.g., access to social media account(s) of the user) or links to one or more content provider websites from where to retrieve the images may be provided by the user. The images uploaded by the user may be real-world images captured by the user or shared by other users or images captured from interactive applications, such as video game applications, travel websites, etc. The images can be user-generated or third-party generated (e.g., content providers, such as promotional media content providers).

In some implementations, the images from or for the user are provided as inputs to a generative artificial intelligence (AI), which analyzes the images to identify the content and the various features of content included within each image. The identified content and features are used by the generative AI to identify a theme for the images. The generative AI also receives user inputs to specify additional customization desired by the user. The user inputs can be in the form of user selection of a specific feature included in an image identified by the user for consideration in generating the theme, and text inputs to adjust the specific feature. For example, the user input can specify inclusion of more of the specific feature, less of the specific feature, exclusion of the specific feature, adjustment of the specific feature present in a selected portion of the image.

Upon identifying the theme, the AI generates an output image for the theme by blending the various features of content from the different images identified by the user. The blending is done by mixing and arranging the different images, wherein the mixing and arranging are done in accordance to the context of content included within, to generate an integrated output image that is a true representation of the theme of the user. While generating the output image, the generative AI takes into consideration the user inputs to adjust the specific feature included in the selected portion of the image. The output image generated for the theme is returned to the client device for presenting to the user. Additional user inputs may be provided by the user to adjust the theme and to further refine the output image. The process of receiving user inputs and refining the output image is done iteratively till the user is satisfied with the output image generated for the user. The finalized output image defines the representative image of the theme. In some implementations, the output image is dynamically modified based on changes to the context of content of the interactive application, wherein the context changes as the user continues to engage in the interactive application. The user can specify the location, interactive application, homepage or screen associated with the user where the output image is to be applied or used. In some implementations, the output image is used to represent the user. In other implementations, the output image is used to identify the user accessing an interactive application or associated with a device to enable uploading of the settings and preferences of the user. The output image is a unique digital fingerprint of the user that can be used to distinctly identify the user and includes portions of uploaded images with features that are customized in accordance to the user's specification. In the case where the output image is used in defining a homepage, the looks of the various icons/interactive applications/widgets and or other interactive elements accessed by the user from their homepage are adjusted to align with the defined theme for the user.

With the general understanding of the disclosure, specific implementations of defining a theme using images uploaded by a user and for generating an output image representing the theme will now be described in greater detail with reference to the various figures. It should be noted that various implementations of the present disclosure can be practiced without some or all of the specific details. In other instances, well known process operations have not been described in detail in order not to unnecessarily obscure various embodiments of the present disclosure.

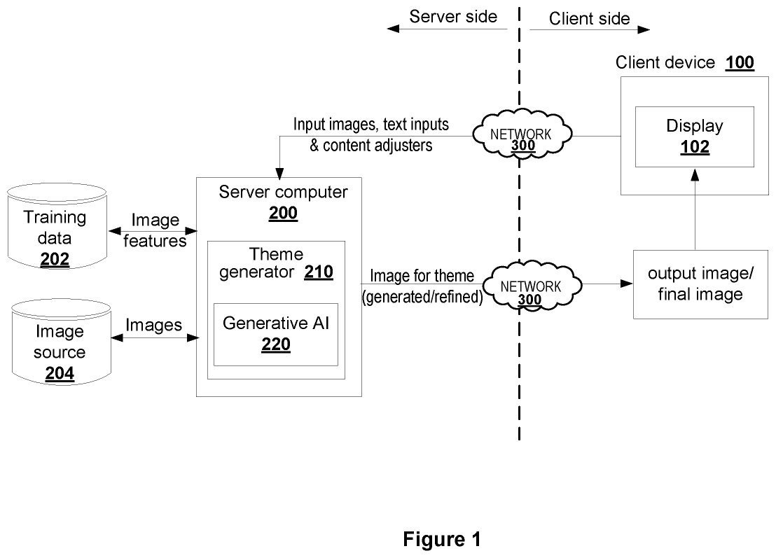

FIG. 1 conceptually illustrates a system used to receive images from or for the user, define the theme from the received images, and generate an output image that represents the theme for the user, in accordance with one implementation of the disclosure.

The implementation illustrated in FIG. 1 includes a client device 100 communicatively connected to a server computer (or simply referred to henceforth as “server”) 200 via a network 300, such as the Internet. The client device 100 is used to access and interact with one or more interactive applications, such as a video game, social media application, etc., that are executing or hosted on or accessed via the server 200. A user of the client device 100 provides inputs that are used in the interactive application to affect an interaction state, such as game inputs used to affect a game state of a video game. The inputs may be provided using any one of input devices (not shown), such as a controller, keyboard, mouse, joystick, touchpad, or any other input device capable of providing inputs. The input devices are communicatively connected to the client device 100 and/or the server 200, so as to convey the inputs provided by the user. Content of the interactive application resulting from applying the inputs is returned to the client device 100 for rendering on a display 102 associated with the client device 100. The display 102 can be integrated with the client device 100 or can be a stand-alone device that is communicatively connected to the client device 100 and/or the server device 200 so as to receive the content for rendering. The server 200 can be part of a cloud system that is accessed via the network 300. In some implementations, the server 200 can be part of a data center that houses a plurality of servers, consoles, server blades, etc. Alternatively, the server 200 can be a stand-alone remote computer.

A theme generator module (or simply referred to as “theme generator”) 210 executing on the server 200 provides a user interface to the client device 100 to allow the user to upload images for generating a theme and an output image for the theme. The user may upload the images that they would like to use for the theme or provide access to images available at an image source 204, such as a social media account or an image library or a content provider website (e.g., content generator, content promoter, content distributor, etc.). The images may be generated by the user, generated and/or shared by other users, or provided by a content provider. In the case where the access to one or more image sources (e.g., social media account, image library) is provided, the images can be retrieved and presented at the user interface with options to select specific ones of the images for inclusion in determining the theme for the user. When the images used are from social media account or user's personal account, the images are retrieved and uploaded from the respective account of the user in accordance to privacy settings defined by or for the user. In some implementations, instead of or in addition to selection options for selecting the specific ones of the images, additional options may be provided at the user interface to allow the user to provide links to certain images available at an image source 204 (e.g., content provider website) so that the theme generator 210 can use the link to retrieve the image(s). Each image uploaded by the user or retrieved from a content source using the link provided by the user is analyzed to identify the various distinct features that are included in different portions of content. The various features identified from the images are provided as inputs to a generative AI, which uses training data 202 to identify the content that correlate with the features identified in the images. The training data 202 includes an aggregation of a plurality of images collected from various sources and from different users, and metadata to identify the various features of content included within. The generative AI uses the content identified from the features of the images to determine a theme that is common to all the images and uses the content and the features from the images to generate an output image that is representative of the theme. The output image is generated by blending the features of the different images used to define the theme.

The output image is returned to the client device 100 for rendering at the display 102. The output image is presented on the user interface along with additional options to further refine one or more portions of the output image. User selection of an additional option associated with a portion of the output image and user input to adjust a certain feature of the selected portion are provided as inputs to the generative AI 220, which applies the user input to adjust the certain feature in the selected portion. The adjusted output image is returned to the client device for review and approval. The process of receiving selection of a portion of the output image and the user input provided through additional options is performed iteratively till the user is satisfied with the changes in the output image for the theme. The resulting output image incorporating the iterative adjustments represents the representative image for the theme for the user. The representative image for the theme is returned to the display 102 with options to use the representative image of the theme in different areas, screens, interactive applications, etc. For example, the representative image can be used to represent the user within an interactive application or for defining a home page or screen saver or navigation screen. In some implementations, the user can select a portion of the representative image to generate a decal for the theme. The decal can be used to identify the user so that the settings and preferences of the user can be automatically uploaded for an interactive application.

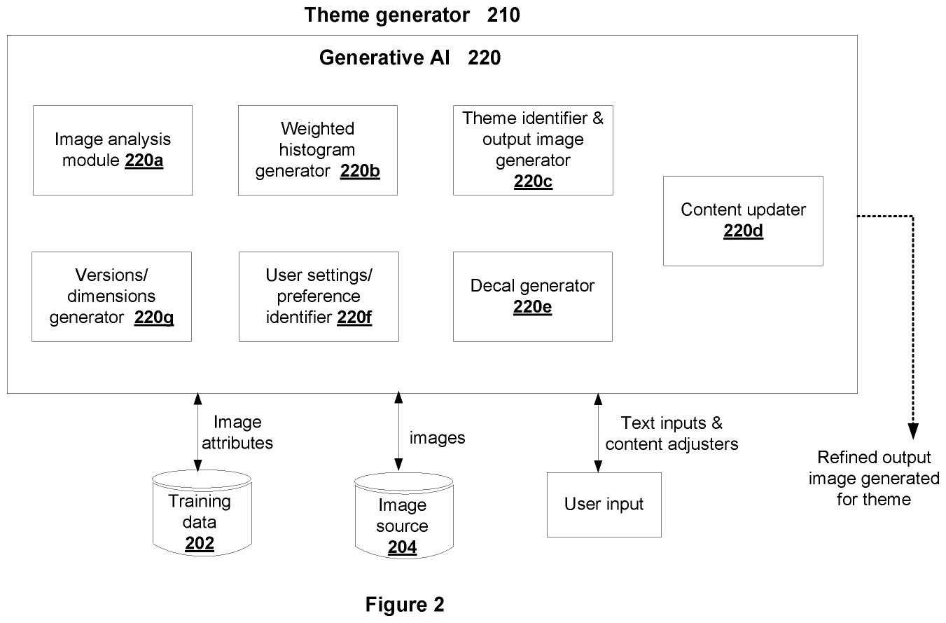

FIG. 2 illustrates some exemplary sub-modules within the generative AI 220 that are used to analyze images uploaded or identified by a user to define a theme and to generate an output image representing the defined theme. In addition to providing the images, the user also provides inputs related to the images in order to control and/or adjust finer details of the images involved in the generation of the output image for the theme. In other words, the user inputs are used to control finer details of the images that are input to the generative AI and the image output by the generative AI. The output image for the theme can be used to represent or identify the user and/or used to customize screens or icons or backgrounds associated with the user or user representation.

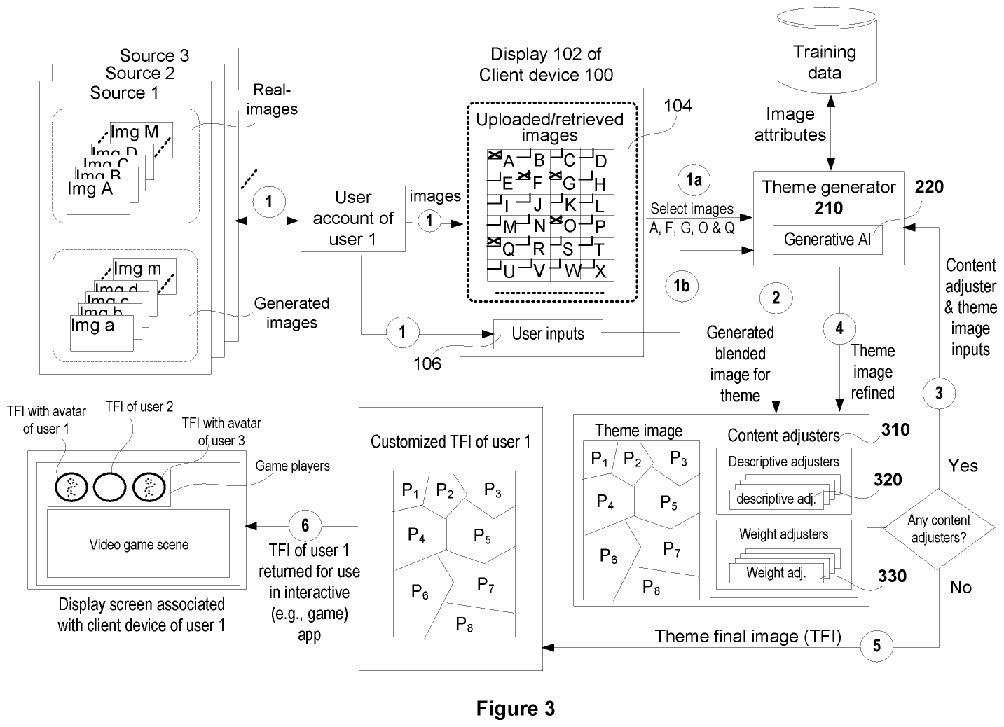

FIG. 3 illustrates flow of data followed by the theme generator 210 to define a theme and to generate and refine an output image for the theme from images uploaded by the user. The images uploaded by the user may be unique to the user or may have sentimental or nostalgic value to the user or may identify a preference of the user.

Referring simultaneously to both FIGS. 2 and 3, a plurality of images are provided by the user to the theme generator 210 for consideration in defining a theme that the user can use in representing or identifying the user. The images provided by the user (shown by bubble 1 in FIG. 3) may be generated by or for the user or shared with the user and can include images generated and shared by other users, content providers, content promoters, etc. The images can include real-images capturing real-elements from a real-world environment or can be images generated to include generated-elements (i.e., virtual elements) that mimic the look and behavior of real-elements or may be defined to have an exaggerated look and/or behavior. In some implementations, the images are uploaded by the user. In alternative implementations, links/access to one or more image sources are provided by the user and the theme generator 210 uses the links/access to retrieve the images for the user. The image sources can include social media account/image library of the user, content provider/content distributor/content promoter websites, image library of other users, etc. The images uploaded by the user or retrieved for the user are presented on a user interface 104 rendered on a display 102 of the client device of the user.

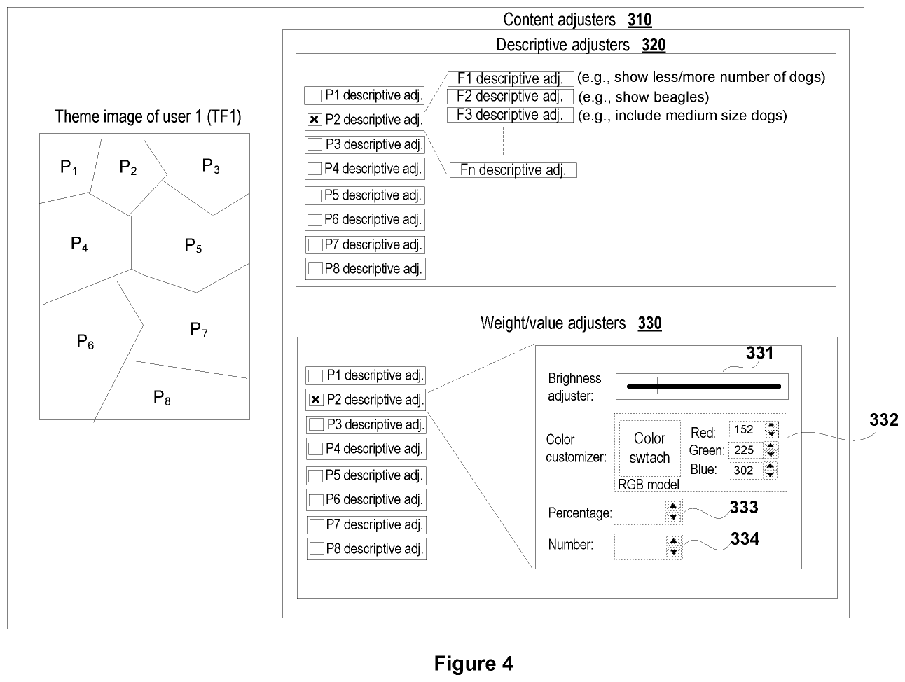

In addition to the images, the user can also provide inputs related to the images presented on the user interface. The inputs can be to select specific ones of the images that was retrieved for the user from one or more content sources. FIG. 3 shows one such example where the user interface 104 shows images retrieved for the user from one or more content sources. The inputs from the user are provided as selections of certain ones of the images that the user wants to consider for defining the theme for the user. In the example, the input from the user includes selection of images A, F, G, O and Q from the plurality of images that were retrieved from a content source and presented at the user interface 104. Responsive to user selection of these images at the user interface 104 of the client device 100, the selected images are forwarded by the client device 100 as image inputs to the theme generator 210 executing at the server 200, as shown by bubble ‘1a’ in FIG. 3. Alternately or additionally, the user may select an image (either user uploaded or retrieved from content source(s)) rendered at the user interface 104 and provide additional inputs. The additional inputs 106 may relate to content included in a portion of the image and any adjustments or changes that the user would like to see to the content. The additional inputs (i.e., user inputs) 106 can be descriptive in nature or can be weighted in nature and appropriate input prompts/options are provided at the user interface 104 to enable the user to provide the additional inputs. Further, the additional inputs can be provided in the form of texts, images, graphics, or can include any other type of inputs that can be provided via user interface. More details of the type of additional inputs that can be provided by the user will be described with reference to FIG. 4. Additional inputs 106 received at the user interface 104 are forwarded by the client device 100 to the theme generator 210 for consideration with the selected images, as shown by bubble ‘1b’ in FIG. 3.

The theme generator 210 receives the images and any user inputs related to the selected images and engages the generative AI 220 to process the images and the user inputs. The generative AI 220 includes a plurality of sub-modules to perform different functions or can work together to process the images and user inputs. FIG. 2 identifies some of the sub-modules within the generative AI 220 used to process the images and the user inputs. The theme generator 210 can be a software module that is executed on the server 200 or defined using hardware at the server 200.

An image analysis module 220a in the theme generator 210 is used to perform the function of analyzing the images. The image analysis module 220a uses training data to identify the content and the features. The training data is an aggregation of images and metadata related to the images collected from various content sources and users. The metadata provides sufficient details to identify content included in the images, context of the content, elements included in the images, features of the elements, characteristics of the features, etc. The metadata and the images within the training data can be used to map descriptive inputs (text inputs or phrases) to specific content or features of content of the images (i.e., real-elements or generated-elements). The image analysis module 220a uses the training data to learn the type of content, context of content, features of content, characteristics of the features included in each image. The results of the analysis are provided as inputs to a weighted histogram generator sub-module (or simply referred to as “histogram generator”) 220b of the generative AI 220.

The histogram generator 220b uses the analysis data to generate a weighted histogram of the various features and the distribution of the features identified from the different images. The weighted histogram is used to determine a weighted distribution (i.e., frequency of distribution) of the different features of content included in the images, which can be used to determine a theme for the user. For instance, if the different images provided as input all capture the same content and/or feature(s) (e.g., picture of dogs or horses or flowers or natural scenery) in different settings, then it is easy to define the theme for the user using the common content or feature of content included in the images. If, however, the user uploads images having different content (e.g., some images of dogs, some of nature, some of user-related events, etc.), then it might be difficult to determine the theme just by looking at the images. In such cases, the weighted histogram can be used to determine the frequency of distribution of each feature or content in the images and use the frequency of distribution of the content/features to identify the theme.

In some implementations, once the weighted histogram is generated for the images, the additional inputs provided by the user are used to adjust the content and/or features included in the corresponding images. For example, if the weighted histogram is heavily weighted toward a particular content or feature of content (i.e., there are too many objects of a particular type (e.g., too many dogs) in the images), then the theme can be determined to be dog-based. Once the theme is identified based on the weights of the content and the features, the user may provide inputs to request reducing the weight of particular content or feature included in the images. The user inputs can be directed toward the content or feature of content that is heavily weighted (e.g., reduce number of dogs in the images for the dog-based theme) or that is less weighted (e.g., less trees serving the background in some of the images with dogs). The user inputs are used to adjust the content or features of content in the images and also the histogram generated for the images. The weighted histogram is provided as input to the theme identifier & output image generator sub-module (or simply referred to henceforth as “theme identifier”) 220c.

The theme identifier 220c uses the weighted histogram to define a theme for the input images provided by the user. In addition to defining the theme, the theme identifier 220c uses the images and any adjustments to the images to generate an output image for the theme. The theme identifier 220c, in some implementations, uses portions of the image that includes the content or features of the theme and blends, mixes and arranges the portions of the image to define the output image. In the example illustrated in FIG. 3, the output image generated to correspond with the defined theme TF1 of the user includes portions P1, P2, P3, P4, P5, P6, P7 and P8 extracted from different input images provided by the user, wherein each portion of the output image is extracted from a different image or two or more portions are extracted from a single image. The output image is returned to the client device 100 for rendering at the user interface, as shown by bubble 2 in FIG. 3. Along with the output image, options 310 to select and adjust certain content or features of content in the output image are also returned to the client device 100 for rendering alongside the output image. The content adjuster options 310 are provided to correspond with each portion of the output image and for the type of content/feature that are included in the output image. Thus, depending on the type of content and features present in the output image, the content adjuster options 310 can include one or more descriptive options 320 where the user is able to provide any one of text inputs, image inputs, graphic inputs, audio inputs, selection inputs, or any two or more combinations thereof, and one or more weight adjuster options 330 for adjusting the weight of a feature or content. The option to adjust the weight can include a sliding scale and/or a percentage field and/or a numerical field, etc.

User selection of a content adjuster option and/or any input provided at the content adjuster option are forwarded to the generative AI 220 to adjust specific portions of the content/feature, as shown in bubble 3 of FIG. 3. The input provided by the user at the content adjuster option selected, in some implementations, can be in the form of text, image, graphic, weight adjustment inputs. The list of inputs that can be provided at the content adjuster options is provided as a mere example and that other types of inputs that can be provided at the user interface can also be considered. The selection of the content adjuster option and the input provided at the selected content adjuster option are provided as inputs to the content updater module 220d (of FIG. 2).

The content updater module 220d identifies the selected content adjuster option and evaluates the input provided at the content adjuster option. Based on the evaluation, the content updater module 220d adjusts (i.e., updates) the one or more content/features in the specific portions of the output image. The inputs can provide instructions to enhance or diminish or replace or delete certain content/features or add other content/features in a portion of the output image and the content updater module 220d applies the input accordingly to update the specific portion of the output image. The updated output image is returned for rendering at the user interface 104 of the client device 100, as illustrated by bubble 4 in FIG. 3. The process of rendering the updated output image at the user interface, receiving user selection of a content adjuster option and user input, and updating the features/content at an identified portion of the output image continues so long as the user is providing the input to adjust the output image. The output image refined to include the user adjustments is used to define the final output image for the theme (TF1) identified for the user, as shown by bubble 5 in FIG. 3. The final output image (TF1) is returned to the client device 100 for rendering at the user interface, as shown by bubble 6 in FIG. 3.

The final output image representing the theme of the input images provided by the user can be used for representing the user within an interactive application, or for customizing a homepage or a navigation screen, or as a screensaver on a display screen associated with the user, or for presenting on a surface of a device of the user, or for identifying the user. The resulting output image is customized for the user and includes portions of images that are unique or personal for the user. In the example shown in FIG. 3, the representative image is used to represent the user in a video game alongside content (i.e., video game scene content) of the video game. The output image generated for the user can be used as a background to an avatar of the user by overlaying an image of the avatar of the user over the output image. User 1 and User 3 are represented by overlaying the image of their respective avatar over the output image generated for User 1 and User 3, respectively. Alternatively, the output image is unique enough to identify the user, and as such is used to represent the user as-is. User 2 is represented using only the output image generated for the theme defined for user 2.

In some implementations, the output image generated for the theme is used to generate a decal that can be presented on a device or on a virtual document or on a digital surface to represent or identify the user. To assist in generating the decal, the final output image of the user is provided to a decal generator 220e (FIG. 2). The decal generator 220e uses the final output image TF1 generated by the theme identifier 220c and refined by the content updater module 220d to generate a decal for the user. In some implementations, the decal is generated automatically by the decal generator 22e by selecting a portion of the final output image TF1 that best represents the theme. In alternate implementations, the decal is generated using inputs from the user, wherein the inputs identify a portion of the final output image TF1 for generating the decal for the user. The user can select the portion using selection options provided at the user interface, in some implementations. The decal generated using inputs of the user is associated with the user profile of the user and can be used for representing the user in an interactive application (e.g., social media application, video games, etc.), or can be printed and affixed to a device, such as a controller or a laptop or a head mounted display or a tablet device or a mouse or other input devices associated with the user, or can be presented on a screen or a digital document or digital scene of an interactive application. The decal identifies a miniature theme and can be used as a background for an avatar representing the user in an interactive application.

A user settings/preference identifier (or simply referred to henceforth as “user settings identifier”) 220f of the generative AI 220 is used to determine the user identity associated with the decal or output image affixed to a device or screen, for example, and to identify and activate the appropriate user settings and preferences for the device, in some implementations. When the decal is affixed to a device (e.g., a controller or input device associated with the user), the decal is scanned by an image capturing device, such as a camera (e.g., external mounted camera or external camera) disposed on a device or in the environment where the user is present, and forwarded to the user settings identifier 220f. The user settings identifier 220f receives the image of the decal, identifies the content and features contained within, queries an output image library using the identified content and features to identify the user associated with the decal. The identity of the user is used to automatically load the settings and preferences of the user.

In some implementations, the theme can be used to set a background for an icon or avatar representing the user. In alternative implementations, the theme can be used to set music on a music rendering device coupled to a computing device, or how a device associated with the user is set to behave (i.e., what settings need to be activated, what preferences need to be set, etc.), or to identify other like-represented users, etc. In some implementations, depending on the interactive environment in which the user is participating, or the context or type of content that the user is interacting with, or the type of other users the user is interacting with, the theme of the user is adjusted dynamically to coordinate with the context of interaction (the context or type of content, the context of environment, or other users). The theme is also used as a digital fingerprint to bring forward the user's identity by correlating the theme and the output image of the theme with the user profile of the user associated with the theme.

In some implementations, the generative AI 220 can use the theme to create variances of the output image for the user. A versions/dimensions generator 220g of the generative AI 220 can be used to determine the content preferences of the user or the context of interaction of the user and generate appropriate variations of the output image for the theme. For example, the versions/dimensions generator 220g can query the user profile or the usage history of the user to determine the content preferences of the user. Based on the results returned for the query, the theme identifier 220c with the aid of the versions/dimensions generator 220g can generate the output image with some variations in the content so as to include content of appropriate genre in at least some portions of the output image. For example, in some implementations, when it is determined that the user has an affinity toward action-related content, the theme identifier 220c can dynamically update the generated output image to include some action-related content or feature in some portions. In other implementations, the different content or features in each portion of the output image can be dynamically adjusted to include some version of action-related content/feature. The generated output image will still relate to the theme defined from the input images provided by the user, but with some features or content relating to the action genre. Similarly, if the user prefers adventure-related content, some of the content/feature of the output image generated for the theme can be dynamically adjusted to include some version of adventure-related content.

Similar to generating multiple dimensions of the output image, wherein each dimension is generated to include some features/content related to a particular genre, the generative AI 220 can also generate multiple versions of the output image based on the context or the environment or the other users that the user interacts with online. For example, the versions/dimensions generator 220g can determine the context or environment or type of users that the user is currently interacting with or is scheduled to interact with, and provide context or the environment or users type to the theme identifier 220c. The theme identifier 220c uses the information provided by the versions/dimensions generator 220g to generate versions of the output image, wherein each version corresponds to a particular environment/context/user type. In some implementations, depending on the context of the interaction, the theme identifier 220c may dynamically generate a professional version of the output image for representing or identifying the user during the user's profession interaction. In alternate implementations, the theme identifier 220c may generate different versions of the output image. In such implementations, the versions/dimensions generator 220g can query the theme identifier 220c for an appropriate version of the output image and the theme identifier 220c may return a specific version of the output image, if available, to the versions/dimensions generator 220g for forwarding to the client device of the user for rendering at the display (i.e., display screen) 102. If the specific version of the output image is not available, then the theme identifier 220c may dynamically generate the appropriate version of the output image and forward it to the versions/dimensions generator 220g. In some implementations, based on the environment or context or user type of other users associated with the user's interactions, the interactions of the user can be broadly classified as professional, personal, family, or friendly interactions. Based on the classification, the theme identifier 220c may generate the appropriate versions of the output image for use in the different context/environment/user type and make the appropriate versions available for use during user's interactions.

In some implementations, the input images provided by the user to define a theme can include real-images capturing images of real-elements from real-world environment, or generated images that include generated-elements. The generated-elements can be virtual elements that mimic the look and behavior or can have an exaggerated look and behavior of the corresponding real-elements. In some implementations, when the input images include the real-images, the output image (and the representative image) for the theme can be generated to include generated images (i.e., generated elements instead of real-elements). In such implementations, the theme generator 210 interprets the features of the real-images using training data and identifying corresponding features of the generated images by matching the respective features. In some implementations, the generated images for the corresponding features of real-images can be maintained in an element datastore (not shown), and the theme generator 210 queries the element datastore and retrieves the appropriate generated images for the real-images. The retrieved generated images for the different real images are blended, mixed and arranged to generate the output image for the theme. The generated output image can be further refined using additional inputs from the user to generate the representative image for the theme. The representative image can be dynamically updated based on changes to context of the interactive application. The representative image with the generated elements may be used by the user to represent them in interactive applications.

FIG. 4 illustrates an example of various content adjuster options available to adjust content in a portion of an output image generated for the theme (also referred to as “theme image”) of the user, in some implementations. As the output image is generated by blending portions of content from different input images, the content adjuster options available at the user interface can vary from one portion to another and can depend on type of content and type of features of content included in each portion of the output image. In the example illustrated in FIG. 4, the output image is shown to include portions P1-P8, wherein each portion can be extracted from a different input image or one or more portions extracted from a single input image. The content adjuster provided for each portion can include additional selection options to enable adjusting content or features of content included in that portion. In some implementations, adjusting content or features of content of the output image include adding a new feature, adjusting an existing feature, replacing an existing feature with a new feature, or excluding the existing feature, and the content adjusters include options to perform each one of the aforementioned adjustments.

The content adjusters include descriptive adjusters and weight/value adjusters, with both the descriptive adjusters and weight/value adjusters including selection options to select each portion of the output image and use the adjusters to adjust certain component of the content or feature included within. Additional selection options for adjusting a specific component of the content and/or features included in the selected portion can be provided upon user selection of a descriptive adjuster or the weight/value adjuster associated with the particular portion of the output image.

In the example illustrated in FIG. 4, user selection of the portion P2 under descriptive adjusters 320 results in the presentation of additional selection options available for the portion P2. The additional selection options within portion P2 are specific to the portion P2 and are provided to allow the user to select and adjust the content or a feature of the content included within the portion P2 as part of fine tuning the output image. It should be noted that the number of portions identified for the output image and the number and type of additional selection options for a selected portion vary from one output image to the next. In FIG. 4, user selection of portion P2 under the descriptive adjusters 320 results in the presentation of additional selection options F1-Fn for providing inputs, wherein the number and type of additional selection options available for the portion P2 correspond with the number and type of content and features available for adjustment in that portion. Not all features available in the portion can be adjusted and therefore such non-adjustable features are excluded when providing the additional selection options. The additional selection options are defined to receive textual input, image input, graphics input, etc. For example, if portion P2 includes dogs, the user can select the feature F1 and provide the text input stating that they would like to see less or more dogs. Feature F2 could be used to provide both image inputs and text inputs. The user can provide the image input of a particular breed of dog (e.g., beagle) to include in the portion and the text input to replace any other breed of dog in the portion with the image of the beagle. F3 could be used to request particular height or weight or size of dogs, etc.

Similarly, user selection of a portion P2 under the weight/value adjusters 330 can result in the presentation of an option to adjust the weight of the particular feature. The option to adjust the weight can be in the form of a sliding scale 331 for adjusting the brightness feature, for example. Alternatively, the option to adjust the weight can be in the form of a color swatch 332, where the weight of the color feature can be adjusted by increasing or decreasing the number value of each of the primary color, or can be a percentage field 333, where the weight of a feature can be reduced by a certain percentage, or a number field 334, where the weight of a feature can be reduced by a certain level. The weight/value adjusters 332-334 are shown in grey scale to show that other options other than the sliding scale 331 can be provided to adjust the weight of a particular feature. User selection and inputs at the respective content adjuster option is used to fine tune the content or feature of the output image.

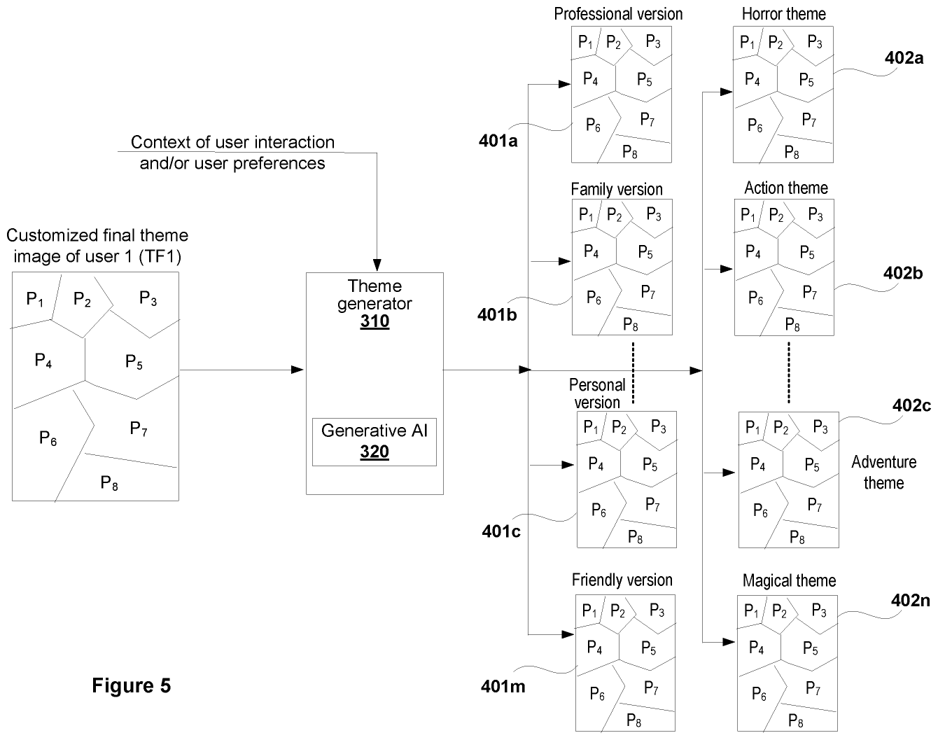

FIG. 5 shows examples of various theme dimensions and theme versions that can be generated by the generative AI 320 for a theme image, in some implementations. As noted previously, the theme image can be customized to include adjustments to content and/or one or more features of content included in the theme image (i.e., output image) by selecting the appropriate portion and appropriate content adjusters for the selected portions. Further customization can be done by the theme generator 210 by determining the user's affinity toward a particular genre and using this affinity of the user to generate different dimensions of the theme image. The user's affinity can be determined by querying the user profile or analyzing the usage history of the user. The user profile or the usage history of the user can be used to determine the user's preference of content. In some implementations, the theme generator 210 may generate theme image for different genre preferred by a plurality of users and provide the appropriate theme image for the user based on the user's preference. Alternatively, the theme generator 210 may use the user preference to dynamically adjust the content of the generated theme image to reflect the genre while maintaining the general theme defined by the input images. FIG. 5 shows examples of the image themes representing the different genres (e.g., horror theme image 402a, action theme image 402b, adventure theme image 402c, magical theme image 402n, etc.) for which content of the theme image has been adjusted.

In addition to determining the user preferences, the theme generator 210 determines the environment in which the user is interacting, the context of user interaction, the type of users the user is interacting with and customizes the theme image of the user. For example, the user may be interacting with other users in a professional setting or in a friendly setting or in a familial setting or in a personal setting, to name a few. The theme generator 210, in some implementations, evaluates the environment (i.e., the interaction setting) to adjust the theme image in accordance to the different settings. Alternatively, the theme generator 210 analyzes the context of the interaction or determines the relationship of the user with the other users that the user is interacting with to determine the type of setting for the user. Based on the evaluation or analysis, the theme generator 210 can dynamically generate or identify and return the appropriate version of the theme image for representing the user during the interactions. For example, based on the analysis/evaluation, the theme generator 210 can return a professional version 401a or a family version 401b or a personal version 401c or a friendly version 401m, etc. of the theme image for representing the user during user interaction.

In some implementations, the various dimensions and versions of the theme image are generated automatically and dynamically by the theme generator 310. In alternate implementations, the dimensions and versions of the theme image are generated based on inputs provided by the user.

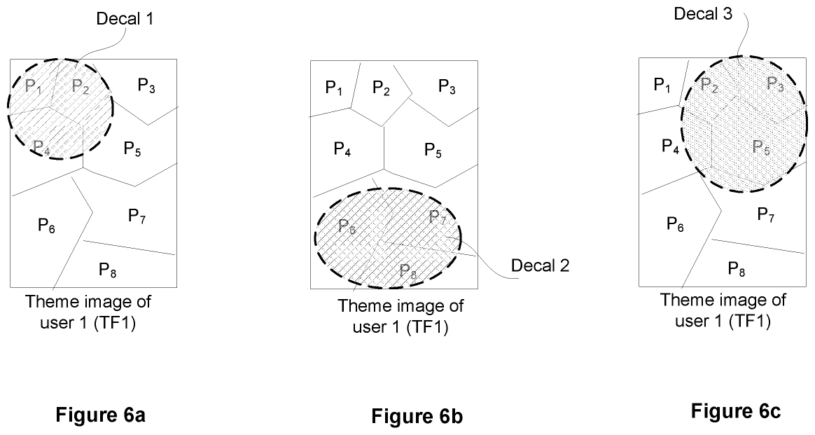

FIGS. 6a-6c illustrate examples of decals generated from the theme image of the user, in some implementations. The decal is generated using content from a region of the theme image generated for the user, wherein the region of the content is identified based on explicit user input or based on the amount of theme related content included in the region. In some implementations, the region can encompass content from a plurality of portions. As shown in FIG. 6a, decal (decal 1) is generated to encompass some of the content from portions P1, P2, P4 and P5 of the theme image TF1 generated for user 1, in one implementation. In another implementation illustrated in FIG. 6b, the decal (decal 2) is generated to encompass some of the content from portions P6, P7 and P8 of the theme image TF1 generated for user 1. In yet another implementation illustrated in FIG. 6c, the decal (decal 3) is generated to encompass some of the content from portions P2, P3, P4 and P5. In some implementations, the decal can be generated using content from a single portion (not shown). In some implementations, more than one decal can be generated by the user. In such implementations, the different decals can be used to represent or identify the user associated with different devices or different content.

The various implementations describe the different ways a user can control generation of a theme used for representing/identifying a user or for customizing a page or screen or icon or an avatar associated with the user. The control is by selectively providing input images that the user would like the theme generator 210 to use for defining the theme and generating theme image and allowing the user to further customize (i.e., fine tune) the different features and content so that the resulting theme image uniquely represents or is personalized for the user.

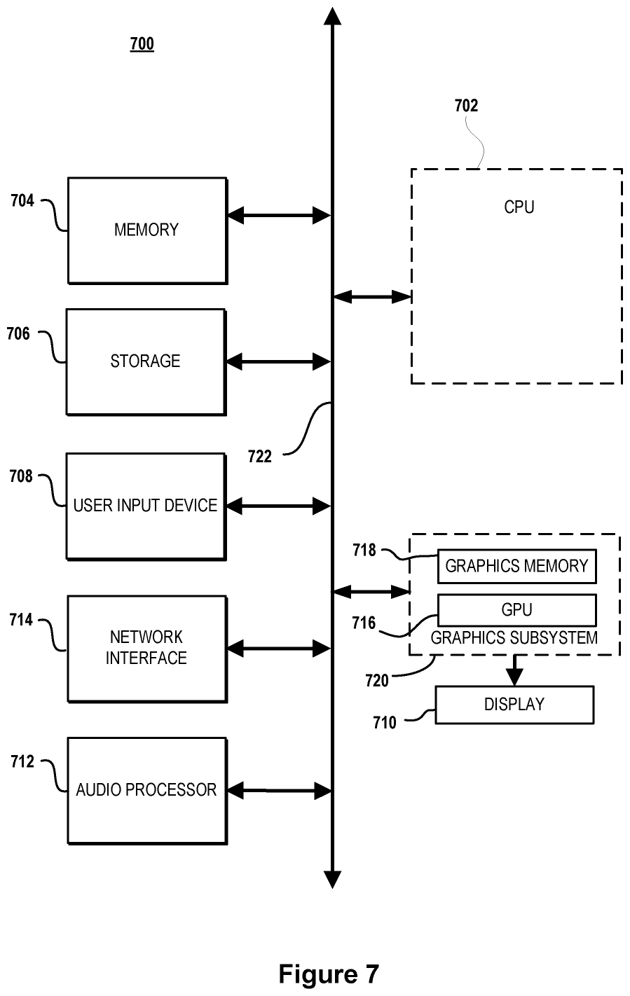

FIG. 7 illustrates components of an example device 700 that can be used to perform aspects of the various embodiments of the present disclosure. This block diagram illustrates a device 700 that can incorporate or can be a personal computer, video game console, personal digital assistant, a server or other digital device, suitable for practicing an embodiment of the disclosure. Device 700 includes a central processing unit (CPU) 702 for running software applications and optionally an operating system. CPU 702 may be comprised of one or more homogeneous or heterogeneous processing cores. For example, CPU 702 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 700 may be a localized to a player playing a game segment (e.g., game console), or remote from the player (e.g., back-end server processor), or one of many servers using virtualization in a game cloud system for remote streaming of gameplay to clients.

Memory 704 stores applications and data for use by the CPU 702. Storage 706 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 708 communicate user inputs from one or more users to device 700, examples of which may include keyboards, mice, joysticks, touch pads, touch screens, still or video recorders/cameras, tracking devices for recognizing gestures, and/or microphones. Network interface 714 allows device 700 to communicate with other computer systems via an electronic communications network, and may include wired or wireless communication over local area networks and wide area networks such as the internet. An audio processor 712 is adapted to generate analog or digital audio output from instructions and/or data provided by the CPU 702, memory 704, and/or storage 706. The components of device 700, including CPU 702, memory 704, data storage 706, user input devices 708, network interface 710, and audio processor 712 are connected via one or more data buses 722.

A graphics subsystem 720 is further connected with data bus 722 and the components of the device 700. The graphics subsystem 720 includes a graphics processing unit (GPU) 716 and graphics memory 718. Graphics memory 718 includes a display memory (e.g., a frame buffer) used for storing pixel data for each pixel of an output image. Graphics memory 718 can be integrated in the same device as GPU 716, connected as a separate device with GPU 716, and/or implemented within memory 704. Pixel data can be provided to graphics memory 718 directly from the CPU 702. Alternatively, CPU 702 provides the GPU 716 with data and/or instructions defining the desired output images, from which the GPU 716 generates the pixel data of one or more output images. The data and/or instructions defining the desired output images can be stored in memory 704 and/or graphics memory 718. In an embodiment, the GPU 716 includes 3D rendering capabilities for generating pixel data for output images from instructions and data defining the geometry, lighting, shading, texturing, motion, and/or camera parameters for a scene. The GPU 716 can further include one or more programmable execution units capable of executing shader programs.

The graphics subsystem 714 periodically outputs pixel data for an image from graphics memory 718 to be displayed on display device 710. Display device 710 can be any device capable of displaying visual information in response to a signal from the device 700, including CRT, LCD, plasma, and OLED displays. Device 700 can provide the display device 710 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video inputs or audio inputs from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction. During HMD use, various kinds of single-handed, as well as two-handed controllers can be u

sed. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for defining a theme for a user to share when interacting with other users, comprising:
presenting a plurality of images available to a user account of the user on a user interface for user selection, each image of the plurality of images includes features to distinctly identify different portions of said image;
receiving selection of select ones of the plurality of images for inclusion in defining the theme for the user;
providing the select ones of the images as inputs to a generative artificial intelligence (AI), the generative AI analyzing the features included in different portions of each of the select ones of the images to determine the theme included within and generating an output image representing the theme for the user by blending the features included in the select ones of the images, the output image returned to a client device for rendering on the user interface, the user interface including content adjusters for refining the output image; and
receiving additional inputs from user selection of one or more content adjusters, the additional inputs provided to the generative AI to adjust one or more features of content included in the output image generated for the theme to define a representative image for the theme, the representative image provided to the user for use to represent the user during interaction within an interactive application.

2. The method of claim 1, wherein the output image is adjusted as and when said additional inputs are received from the user.

3. The method of claim 1, wherein the theme is generated by the generative AI by analyzing the features included in the different portions of the select ones of the images using a weighted histogram.

4. The method of claim 3, wherein said content adjusters provided in the user interface include any one of descriptive adjusters, or weighted adjusters, or a combination of said descriptive adjusters and said weighted adjusters, and
wherein said inputs provided using the descriptive adjusters or the weighted adjusters define said additional inputs that are provided to the generative AI to adjust the content of the output image.

5. The method of claim 1, wherein the output image is analyzed to identify portions of content, wherein each portion of content of the output image is defined to include said content from a distinct image of the select ones of the images, and
wherein one or more of the content adjusters include at least a distinct content adjuster for adjusting each portion of the portions of content identified for the output image.

6. The method of claim 5, wherein the content in said each portion includes a plurality of features that is specific for said each portion, and the one or more content adjusters includes a distinct content adjuster identified to adjust each feature of the plurality of features of said each portion.

7. The method of claim 1, wherein the plurality of images presented at the user interface are uploaded by the user or are retrieved from one or more content sources, wherein the one or more content sources include a social media account of the user accessed via the user account or a website of a content provider accessed over a network,
wherein the images in the social media account are generated by the user or shared by the user or other users, the plurality of images retrieved and uploaded from the social media account in accordance to privacy setting defined by the user, and
wherein the images are identified and retrieved from the website using links provided by the user at the user interface.

8. The method of claim 1, wherein the additional inputs used for adjusting the one or more features of content of the output image further include any one of text inputs, image inputs, graphic inputs, audio inputs, selection inputs, or any two or more combinations thereof, the additional inputs provided to the generative AI for interpreting and adjusting the one or more features of content of the output image.

9. The method of claim 1, wherein receiving said selection of the select ones of the plurality of images further includes,
receiving a selection of a portion of each image of the select ones of the images, wherein the portion selected includes content with distinct features,
wherein the portion of said each image is selected using a selection option corresponding to the portion provided on the user interface.

10. The method of claim 9, wherein adjusting the one or more features of content of the output image includes adding a new feature, adjusting an existing feature, replacing the existing feature with the new feature, or excluding the existing feature, and the additional inputs are provided for performing the adjustment to the one or more features of content in a selected portion of the output image.

11. The method of claim 9, wherein the one or more features of content identified for adjusting is specific to the selected portion of the output image, and the user interface includes the content adjuster corresponding to each feature of the one or more features included in the selected portion, the additional inputs provided using the content adjusters provided to the generative AI for adjusting the selected portion of the output image.

12. The method of claim 1, wherein the representative image of the theme functions as a digital finger print to identify the user during interaction in one or more interactive applications.

13. The method of claim 1, further includes selecting a region of the representative image for the theme to generate a decal, the decal generated is associated with a user profile of the user, the region encompassing one or more portions of the representative image.

14. The method of claim 13, wherein the decal is used to identify the user and to automatically load settings and preferences of the user at the interactive application.

15. The method of claim 13, wherein the decal is used to identify a device used by the user for providing interactions to the interactive application, when the decal is provided on the device, the identification of the device used in loading user settings of the user associated with the device.

16. The method of claim 13, wherein the decal identifies a miniature theme and is used as a background for an avatar representing the user in the interactive application.

17. The method of claim 1, wherein the output image is dynamically modified based on context of content of the interactive application that the user is engaged in interaction.

18. The method of claim 1, wherein the analyzing of the features is performed automatically by the AI to identify said features included in the images for generating the theme or is performed based on input provided by the user to identify portions of the images for inclusion in generating the theme.

19. The method of claim 1, wherein the representative image generated for the theme includes real-elements blended with generated elements.

20. The method of claim 1, further includes generating different dimensions of the theme, each dimension corresponding to a distinct genre, wherein the distinct genre is identified from user preferences determined from content usage history of the user or from user profile of the user.

21. The method of claim 1, wherein generating the representative image for the theme includes generating different versions of the representative image, wherein each version of the representative image generated to correspond with context of content, or a type of environment in which the user is interacting, or identity of other users the user is interacting with, or a type of content that the user is interacting in the interactive application, and
wherein providing the representative image further includes identifying a specific version of the representative image for presenting to the user, based on context of interaction of the user.

22. The method of claim 1, wherein the select ones of the plurality of images, used to generate the output image and the representative image for the theme include real-images or generated images or a combination of real-images and generated images,
wherein the real-images are defined using real-elements captured from real-world environment,
wherein the generated images are defined using generated elements defined to mimic a look and behavior of corresponding real-elements, and
wherein the generated elements are virtual elements.

23. The method of claim 22, wherein when the select ones of the plurality of images include the real-images, the output image and the representative image include the generated images, the generated images are defined by,
interpreting the features of the real-images and identifying corresponding features of the generated images using training data available to the generative AI; and
defining the output image and the representative image by blending the features of the generated images.

24. The method of claim 1, wherein the representative image is dynamically updated based on changes to context of the interactive application.
